(19) United States
(12) Patent Application Publication
(10) Pub. No.: US 2007/0229566 A1
(43) Pub. Date: Oct. 4, 2007

(54) LIQUID DISCHARGE HEAD AND LIQUID DISCHARGE APPARATUS USING LIQUID DISCHARGE HEAD

(75) Inventors: Hiroshi Takabayashi, Atsugi-shi (JP); Hideo Kanno, Yokohama-shi (JP); Takatsuna Aoki, Yokohama-shi (JP); Seiichiro Karita, Toda-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/689,855

(22) Filed: Mar. 22, 2007

(30) Foreign Application Priority Data
Mar. 31, 2006 (JP) 2006-098674
Mar. 15, 2007 (JP) 2007-066591

(51) Int. Cl. B41J 29/38; B41J 29/393

(52) U.S. Cl. 347/17; 347/19

(57) ABSTRACT

In order to provide a compact and highly reliable recording head enabling precise detection of temperature information on each nozzle and rapid as well as highly accurate detection on nozzles with a discharge defect, a liquid discharge head including a liquid discharge head with a plurality of electrothermal transducing members provided on a substrate to generate heat energy for discharging liquid from a discharge port includes a temperature detecting element formed immediately under each of the plurality of electrothermal transducing members to sandwich insulating film and a temperature detecting circuit for detecting temperature information from each of the temperature detecting elements.

### BACKGROUND OF THE INVENTION

1. Field of the Invention

The present invention relates to a liquid discharge head and a liquid discharge apparatus using the liquid discharge head.

2. Description of the Related Art

An ink jet printer (ink jet recording apparatus) is now being widely used as a liquid discharge apparatus. An ink jet head is used as a liquid discharge head in that printer. That ink jet head is based on various types of liquid discharge principles. The widespread type in particular is an ink jet head applying thermal energy to ink to discharge ink drops from a discharge port. That type of ink jet head is advantageous in that responsiveness to record signals is good and enhancement in high density of the discharge port on a multilevel basis is easy.

However, in an ink jet printer (ink jet recording apparatus) with such an ink jet head, foreign material occasionally blocks the discharge port or bubbles mixed into inside the ink supply route occasionally blocks the ink supply route thereof. An occurrence of such events will result in ink discharge defects of an ink jet head. In particular, a so-called full-line type recording apparatus provided with a great number of discharge ports being arranged in a lined state enabling ink jet recording corresponding with the entire width of recording media enables rapid recording execution. Nevertheless, it is extremely important to specify the discharge port (discharge nozzle) having caused discharge defects rapidly to be reflected onto image complementation and ink discharge recovering work.

Technology for solution of such discharge defects is known.

Japanese Patent Application Laid-Open No. H6-079956 describes a recording method, moving image data to be given to an abnormal recording element to image data to be given to another recording element even in an occurrence of abnormality in a recording element and thereby causing that another recording element to complement the record. However, that recording method carries out processing of reading a check pattern discharged onto a detection sheet to detect an abnormal recording element and to superpose image data to be added to that detected recording element onto image data of another recording element. That processing is applicable to a recording apparatus with slow response speed but is hardly applicable to a recording element with fast response speed such as a full-line type recording apparatus.

Moreover, Japanese Patent Application Laid-open No. H2-276647 describes a recording apparatus for detecting a discharge port having cased discharge defects in a line-type recording head to carry out recording with a serial type recording head on a recording position corresponding with that discharge port. However, that discharge defect detection method detects transmits a heat timing signal to a heat generating resistor member, detects a signal flowing in the heat generating resistor member at that occasion to detect whether or not the heat resistor member is broken.

Moreover, Japanese Patent Application Laid-Open No. S58-118267 described a recording head as illustrated in FIG. 16. There described is a liquid discharge apparatus provided with a temperature change detecting conductor portion 102 inside a flow channel (inside a nozzle) between adjacent electrothermal energy transducing members 101, including a plurality of nozzles 100 arranged in a row. Moreover, there also described is a liquid discharge apparatus provided with a conductor portion 102 on the rear surface of the side opposite to the surface of a substrate 103 provided with an electrothermal energy transducing member 101 and in a position corresponding with a nozzle 100. However, the case where the conductor portion 102 is provided sideway of the electrothermal energy transducing member 101 is susceptible to influence of heat of the adjacent electrothermal energy transducing member and is susceptible to influence covering thickness of the substrate 103 in the case of providing the conductor portion 102 on the rear surface side of the substrate 103. Therefore, it becomes difficult to precisely detect temperature changes occurring due to repetition of rapid temperature increase and decrease within an extremely short time period.

### SUMMARY OF THE INVENTION

An object of the present invention is to provide a compact and highly reliable recording head enabling precise detection of temperature information on each nozzle and rapid as well as highly accurate detection on nozzles with a discharge defect.

Another object of the present invention is to provide a liquid discharge head including a plurality of electrothermal transducing members provided on a substrate to generate heat energy for discharging liquid from a discharge port, including a temperature detecting element formed immediately under each of the plurality of electrothermal transducing members to sandwich insulating film; and a temperature detecting circuit for detecting temperature information from each of the temperature detecting elements.

Further features of the present invention will become apparent from the following description of exemplary embodiments with reference to the attached drawings.

### BRIEF DESCRIPTION OF THE DRAWINGS

FIG. 1 is a sectional view of a recording head mounted on a recording apparatus being a first embodiment of the present invention.

FIG. 2 is a plan view of the recording head mounted on the recording apparatus being the first embodiment of the present invention.

FIG. 3 is a condition chart illustrating temperature profiles on an ink interface of cavitation-resistant film in the recording head mounted on the recording apparatus being the first embodiment of the present invention.

FIG. 4 is a condition chart illustrating temperature profiles in a temperature detecting element of the recording head mounted on the recording apparatus being the first embodiment of the present invention.

FIGS. 5A and 5B are condition charts illustrating temperature profiles as simulations on an arrangement position of a temperature detecting element.

FIG. 6 is a block diagram illustrating a schematic configuration of a heater control circuit and the temperature detecting circuit applied to the recording head illustrated in FIG. 1 and FIG. 2.

FIG. 7 is a timing chart illustrating operations of the heater control circuit illustrated in FIG. 6.

FIG. 8 is a block diagram illustrating a configuration of a circuit, to which the temperature of detecting circuit illustrated in FIG. 6, outputting a determination signal notifying non-discharge.

FIG. 9 is a plan view illustrating another shape of the temperature of detecting element used in the recording head mounted on the recording apparatus being the first embodiment of the present invention.

FIG. 10 is a plan view of a recording head mounted on a recording apparatus being a second embodiment of the present invention.

FIG. 11 is a block diagram illustrating a schematic configuration of a control circuit and a temperature detecting circuit applied to the recording head illustrated in FIG. 10.

FIG. 12 is a timing chart illustrating operations of the control circuit illustrated in FIG. 11.

FIG. 13 is a block diagram illustrating a configuration of a circuit, to which the temperature detecting circuit illustrated in FIG. 11 is applied, for outputting determination signals.

FIG. 14 is a plan view illustrating another shape of the temperature of detecting element used in the recording head mounted on the recording apparatus being the second embodiment of the present invention.

FIG. 15 is a block diagram illustrating a configuration of a circuit applied to the recording apparatus being the second embodiment of the present invention for transducing temperature information to digital values.

FIG. 16 is a perspective view illustrating major portions of a recording apparatus of a prior art.

### DESCRIPTION OF THE EMBODIMENTS

Next, embodiments of the present invention will be described with reference to drawings.

### First Embodiment

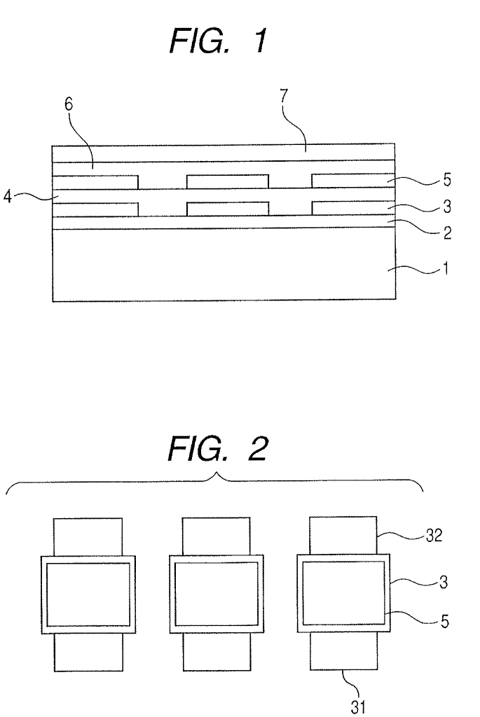

FIG. 1 and FIG. 2 are a sectional view and a plan view respectively of a recording head mounted on a recording apparatus being a first embodiment of the present invention. In FIG. 1 and FIG. 2, a discharge nozzle portion including a discharge port, a liquid route and the like is omitted.

With reference to FIG. 1, a heat accumulating layer 2 is formed on a Si substrate 1. A plurality of temperature detecting elements 3 is formed on the heat accumulating layer 2. A plurality of heaters 5 is formed on the heat accumulating layer 2 in which the temperature detecting element 3 is formed to sandwich interlayer insulating film 4. Moreover, cavitation-resistant film 7 is formed on the surface where the heaters 5 are formed to sandwich passivation film 6. Respective layers selected from the group including the heat accumulating layer 2, the temperature detecting element 3, the interlayer insulating film 4, the heaters 5, the passivation film 6, the cavitation-resistant film 7 are highly densely stacked with known semiconductor processing.

The heat accumulating layer 2 is a thermally-oxidized film such as SiO₂. The temperature detecting element 3 includes thin film resistor member selected from the group including Al, AlCu, Pt, Ti, TiN, TiSi, Ta, TaN, TaSiN, TaCr, Cr, CrSiN, W. The heaters 5 include an electrothermal transducing member such as TaSiN. The passivation film 6 includes SiO₂ and the like. The cavitation-resistant film 7 intensifies cavitation-resistant properties of the heaters 5. The thin film resistor member included in the temperature detecting element 3 is formed separately and independently immediately below the electrothermal transducing member included in each heaters 5.

The temperature detecting elements 3 and the heaters 5 are all rectangular as illustrated in FIG. 2. The area of a temperature detecting element 3 is larger than the area of a heater 5. In the case of viewing the heaters 5 from the upper side of the Si substrate 1, the heater 5 is positioned approximately in the center of the temperature detecting element 3. An end (terminal) of the temperature detecting element 3 is connected to individual wiring 31. The other end (terminal) is connected to common wiring 32. The individual wiring 31 and the common wiring 32 made of Al and the like and is formed together with the temperature detecting element 3 on the Si substrate 1. Here, circuits selected from the group including a switching element, a control circuit, a circuit for detecting temperature are not illustrated in FIG. 1 and FIG. 2 but are formed on the Si substrate 1 in order to control the temperature detecting element 3 and heaters 5.

According to the recording head of the present embodiment, the temperature detecting element 3 is formed immediately under the heaters 5 (between the heaters 5 and the Si substrate 1). Therefore the temperature changes due to heat dissipation from the heaters 5 can be detected rapidly and accurately. In addition, the condition having discharged ink normally and the condition with non-discharge of ink can be determined precisely. The reasons will be described below specifically.

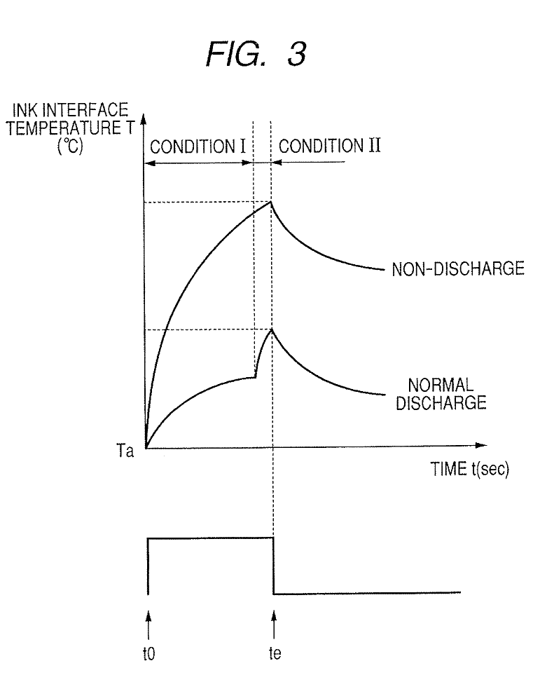

At first, the temperature changes in the ink interface of the cavitation-resistant film 7 will be described when the heaters 5 undergo and off operations. FIG. 3 is a condition chart illustrating temperature profiles on an ink interface of cavitation-resistant film. FIG. 3 illustrates the temperature profiles in the case where ink is discharged normally and in the case of ink non-discharge respectively. Both of the temperature profiles illustrate the result obtained by temperature simulation with a computer.

In the case of the normal discharge, the heater 5 increases temperature from the point of time (timing to supply an application start signal t0) when electric energy is applied to an electrothermal transducing member included in the heater 5. Corresponding therewith, the temperature rises on the ink interface between the cavitation-resistant film 7 and the ink (condition I). The interface temperature of the cavitation-resistant film 7 reaches a constant temperature. Then bubbles are generated in the ink rapidly so as to bring the interface of the cavitation-resistant film 7 into a condition not to contact the ink directly. Consequently, the heaters 5 and the cavitation-resistant film 7 increase temperature rapidly due to the condition not to contact the ink directly (condition II). In a lapse of a constant time, supply of electric energy to the electrothermal transducing member is stopped (timing to supply an application stop signal te). Then the temperature of the heaters 5 and the cavitation-resistant film 7 drops gradually. Consequently, the bubbles in the ink disappear to bring the ink and the interface of the cavitation-resistant film 7 back to the initial contact condition.

On the other hand, in the case of the non-discharge, on and after the point of time when electric energy is applied to the electrothermal transducing member (timing to supply an application start signal t0), the temperature of the cavitation-resistant film 7 rises rapidly. For example, in the case of occurrence of ink non-discharge due to clogging of the flow channel with the bubbles, the ink and the interface of the cavitation-resistant film 7 are brought into a condition not to contact each other directly. Therefore, the temperature of the interface of the cavitation-resistant film 7 rises more rapidly than in the case of the normal discharge. In a lapse of a constant time, supply of electric energy to the electrothermal transducing member is stopped (timing to supply an application stop signal te). Then the temperature of the heaters 5 and the cavitation-resistant film 7 drops gradually.

Next, the temperature changes detected with the temperature detecting element 3 will be described when the heaters 5 undergoes on and off operations.

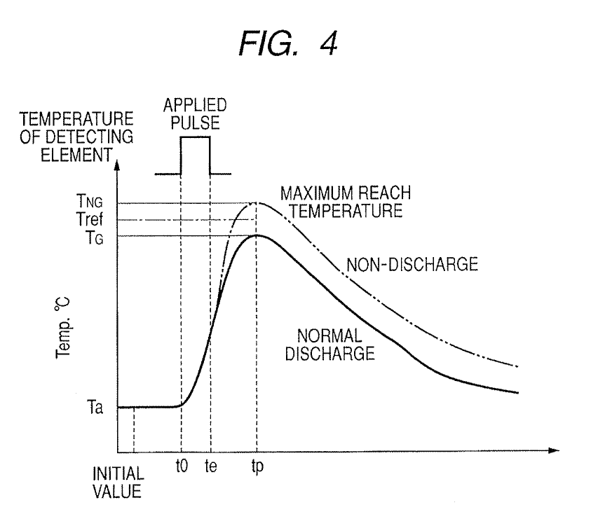

FIG. 4 is a condition chart illustrating temperature profiles in the temperature detecting element 3. FIG. 4 illustrates the temperature profiles in the case where ink is discharged normally and in the case of ink non-discharge respectively. Both of the temperature profiles illustrate the result obtained by temperature simulation with a computer.

In FIG. 4, the time t0 is timing when the application start signal is supplied. The time te is timing when the application start signal is supplied and is set to the timing in 0.8 μsec after the time t0. The heaters 5 are electrothermal transducing members with a resistant value of 200Ωand are driven by a pulse drive signal of 18 V. The drive condition for those heaters 5 is basically the same as temperature simulation in FIG. 3.

In both cases of normal discharge and non-discharge, at the time tp in substantially 1.2 μsec from the timing te, the temperature value reaches the maximum temperature of the peak. The time period from the timing te up to the timing tp when the temperature value reaches a peak is a delay in the process of transmitting the heat generated by the heaters 5 to the temperature detecting element 3. The delay time thereof is 1.2 μsec and is small. The result thereof tells that the temperature detecting element 3 has a rapid response property. That is a characteristic obtained by the structure with the temperature detecting element 3 being arranged immediately below the electrothermal transducing members (heaters 5) (the Si substrate side) through the interlayer insulating film 4 having substantially 1.3 μsec thickness.

In addition, the temperature peak value T_{G} in the case of a normal discharge is 218° C. The temperature peak value T_{NG} in the case of non-discharge is 260° C. The balance between the both temperature peak values is 52° C. Thus, the balance between the temperature peak values at the time of normal discharge and at the time of non-discharge is sufficiently large. Therefore, setting the standard temperature value Tref between the temperature peak value T_{NG} and the temperature peak value T_{G}, it is possible to precisely determine the respective conditions of the normal discharge and the non-discharge. That is a characteristic obtained by the structure with the temperature detecting element 3 being arranged immediately below the electrothermal transducing members through the interlayer insulating film between layers 4 having substantially 1.3 μm thickness as described above.

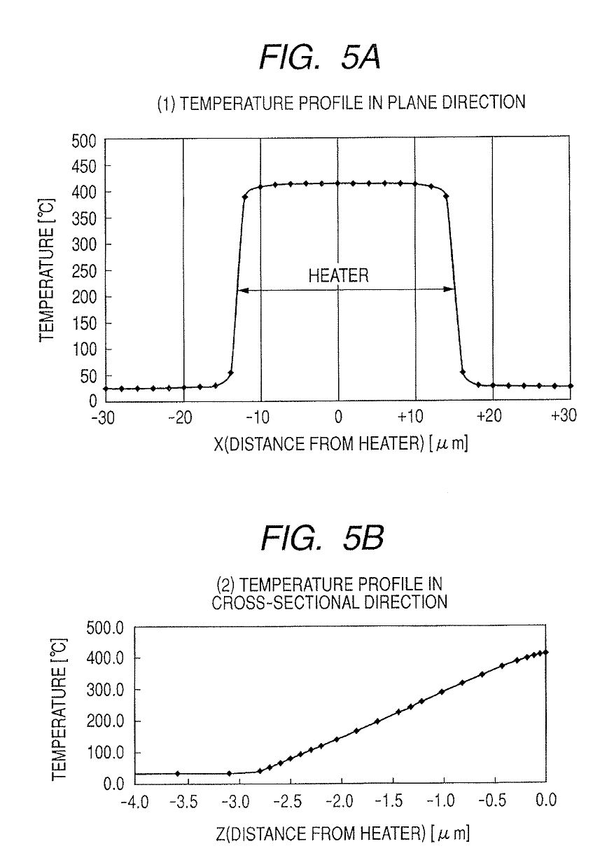

Next, in order to search for the optimum arrangement position of the temperature detecting element 3 on the heater 5, a computer was used to carry out simulation. FIGS. 5A and 5B illustrate temperature profiles including temperature drops in respective positions apart in the direction along the surface of the Si substrate and temperature drops in respective positions apart in the direction perpendicular to the surface of the Si substrate obtained by simulation with a computer.

FIG. 5A simulates temperature in a position apart from the heater center in the direction of the heater side along the Si substrate surface. The positions located at +12 μm and located at −12 μm from the center of the heater are equivalent to the heater end portions.

In addition, FIG. 5B simulates the temperature in respective positions with the direction apart from the Si substrate as positive in the direction perpendicular to the surface of the Si substrate from the center of the bottom surface of the heater. FIG. 5B is a temperature profile on the Si substrate side (the position to become negative in terms of distance from the heater).

The simulation hereof will be described in details below.

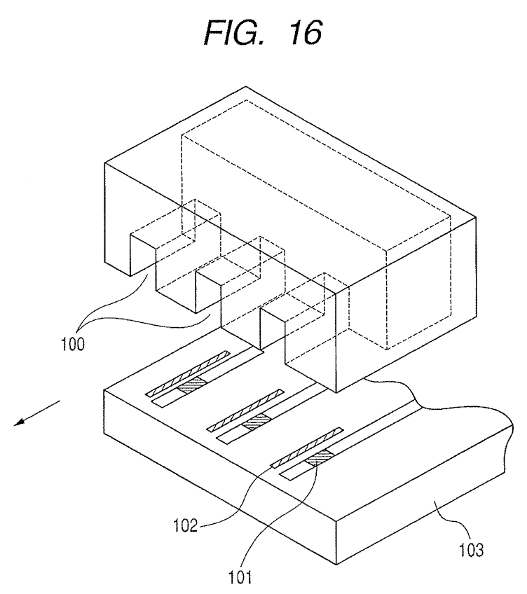

In the substrate temperature profile in planar direction in FIG. 5A, temperature drops rapidly in the heater circumferential portion (position approximately at 15 μm from the heater center), the temperature remain low, giving rise to few temperature shifts. This tells that in the case of arranging the temperature detecting elements in the position as in FIG. 16 describing a prior art (the position extending sideway toward along the substrate plane toward the heater) does not enable detection of rapid and precise heater temperature. Moreover, in the future, accompanied by heaters being highly densely arranged, it will be difficult to secure the space to arrange the temperature detecting elements. In addition, it is apparent that consideration of constraints and the like on adjacent arrangement of heaters and temperature detecting elements due to various circumstances such as photoprocess resolution and the like at the time of fabrication does not enable arrangement, sideway of the heaters, of the temperature detecting elements enabling exact detection of temperature.

In addition, the temperature profile in cross-sectional direction of the substrate in FIG. 5B illustrates temperature dropping approximately linearly from the bottom plane of the heaters to the position (−2.8 μm) of approximately 2.8 μm toward the Si substrate side to thereafter reach constant temperature. That simulation employs an SiO₂ layer from 0 μm to −2.8 μm to an Si layer (Si substrate) from the position of −2.8 μm. An actual head substrate includes 1 μm to 2 μm insulating film between layers and a several-thousand A heat accumulating layer thereunder. An Si substrate is present below the heat accumulating layer, where a semiconductor element for heating to drive heaters corresponding with ink discharge signals (see FIG. 1). The present simulation has been implemented with the temperature detecting element having been arranged at the position of −1.4 μm. The result thereof tells that the case of the temperature detecting element being arranged inside the Si substrate does not enable rapid response and preciseness for detecting defective discharge each for discharge timing on the level to be detected in the present embodiment.

The present embodiment includes the temperature detecting element 3 arranged apart from the heaters 5 intermediated by an interlayer insulating film 4 in the position below the heaters 5 and above the heat accumulating layer 2 (in the position nearer the heaters). Moreover, the temperature detecting element 3 is arranged immediately below the heaters. There, immediately below refers to mutual positional relation so as to stack at least the heaters 5 and the temperature detecting elements 3 in the direction perpendicular to the surface of the substrate. More preferably, such relation so as to bring the central positions of the heaters and the temperature detecting element into correspondence is better. There, the heat accumulating layer 2 is a type of heat insulating layer provided under the heaters 5 (on the Si substrate side) in order to transmit heat energy generated by the heaters 5 to the ink in the ink flow path above the heaters 5. Therefore, the temperature detecting elements 3 are arranged in the position upper than the heat accumulating layer 2 (closer to the heaters) as that heat insulating layer.

The result thereof tells that the temperature detecting elements 3 are arranged below the heaters 5 (on the substrate side), that is, beyond the heaters 5 and between the heaters 5 and the heat insulating layer (heat accumulating layer 2) via the interlayer insulating film 4 as an insulating layer, thereby enabling temperature detection including rapid responsiveness and preciseness.

Here, it is apparent that a configuration to arrange the temperature detecting elements inside the Si substrate or on the rear surface of the Si substrate with several hundred μm thickness as comparison enables detection of temperature changes over the head after head drive for several minutes but not further. In addition, the configuration with the temperature detecting elements arranged sideways of the heaters is likewise. In any event, it is extremely difficult for the configuration to be treated as comparison to detect and determine temperature information corresponding with each nozzle rapidly each for discharge timing.

Next, a temperature detecting circuit for detecting temperature through a heat controlling circuit for controlling the drive of the heaters 5 and the temperature detecting element 3 will be described.

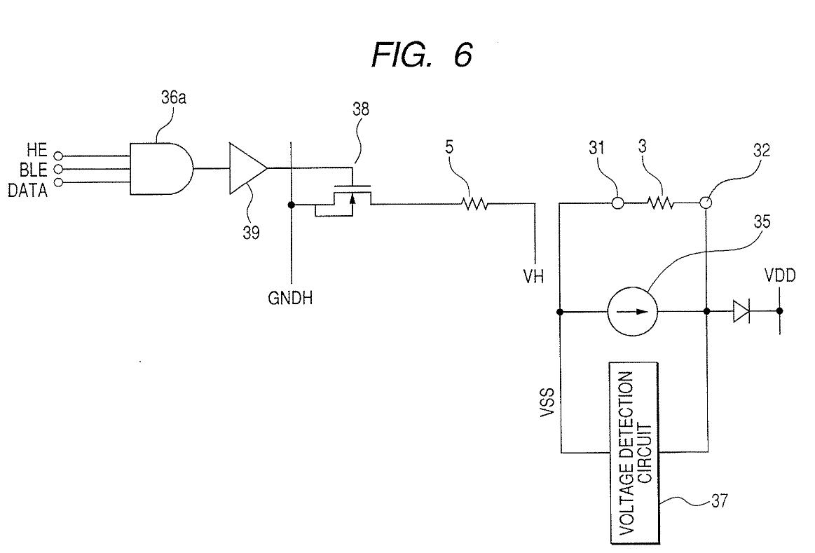

FIG. 6 is a block diagram illustrating a schematic configuration of a heater controlling circuit and the temperature detecting circuit applied to the recording head illustrated in FIG. 1 and FIG. 2. With reference to FIG. 6, individual wiring 31 and 32 connected to each terminal of the temperature detecting element 3 configures a part of a temperature detecting circuit for detecting temperature information from the temperature detecting element 3. The temperature detecting circuit has a constant current circuit 35 for supplying the temperature detecting element 3 with constant current and a voltage detection circuit 37 for detecting voltage generated between the individual wiring 31 and 32.

The heater controlling circuit has an AND circuit 36a for controlling the drive of the heaters 5. One terminal of the individual heater 5 is connected to the ground line GNDH via the switching element 38 (an nMOS transistor, for example). The other terminal is connected to a voltage supplying line VH. The AND circuit 36a takes a heater applied signal HE, a block selection signal BLE and a stored data DATA as an input respectively to derive logical multiplication of those inputs. Outputs of the AND circuit 36a are supplied as a switching element controlling signal to the switching element 38 via the amplifying circuit 39.

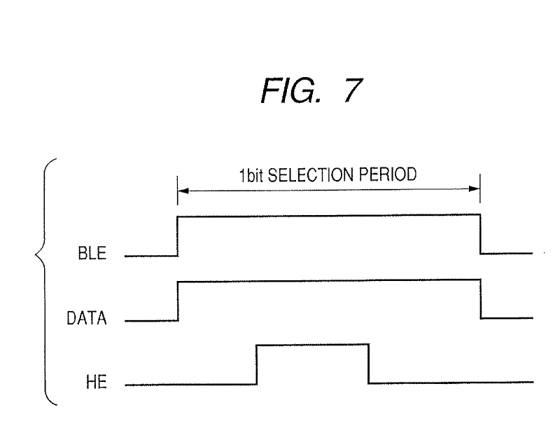

FIG. 7 is a timing chart illustrating operations of the heater controlling circuit illustrated in FIG. 6. The block selection signal BLE designates one bit selection period. The stored data DATA is set to take a high level (corresponding with “1”) for the one bit selection period. Therefore, for the period with the block selection signal BLE being on a high level, the outputs of the AND circuit 36a will reach a high level. For the period with the outputs of the AND circuit 36a being on a high level, the switching element 38 is put on to supply the heater 5 with voltage.

The heaters 5 transduce electric energy to heat energy. With the heat energy from that heater 5, the temperature detecting element 3 provided immediately below the heaters 5 generates temperature changes according to the temperature profiles illustrated in FIG. 4. Based on the voltage value detected by the voltage detection circuit 37, information (temperature information) corresponding with temperature changes in temperature detecting element 3 thereof is obtainable.

The above described heater controlling circuit and the temperature detecting circuit may be formed on the Si substrate 1 illustrated in FIG. 1 or may be formed on a substrate different from the Si substrate 1.

Temperature information is obtained from the output signals (detected voltage) of the voltage detection circuit 37 to enable determination on whether a non-discharge state occurs or not based on that obtained temperature information. The determination on the non-discharge state is implemented based on the reference temperature value Tref illustrated in FIG. 4. Specifically, the case where the detected temperature value of the temperature detecting element 3 obtained based on the output signals of the voltage detection circuit 37 exceeds the preset reference temperature value Tref is determined to be a state of non-discharge. The circuit for determining the state of that non-discharge may be formed on the Si substrate 1 illustrated in FIG. 1 or may be formed on a substrate different from the Si substrate 1.

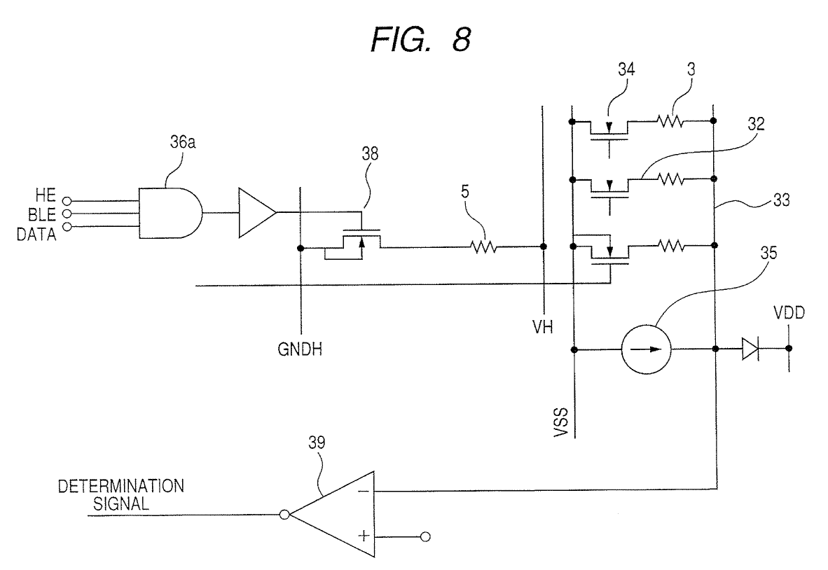

Next, applying the temperature detecting circuit illustrated in FIG. 6, a circuit for outputting the determination signal presenting non-discharge will be described. FIG. 8 illustrates the configuration of that circuit.

The circuit illustrated in FIG. 8 is provided with a comparator 39 replacing the voltage detection circuit in the circuit illustrated in FIG. 6. An “−” side input (inverting input) of the comparator 39 is connected to the line to which the individual wiring 32 is connected. The “+” side input (non-inverting input) of the comparator 39 is provided with reference voltage Vref.

The comparator 39 brings voltage Vt (temperature information) supplied to the “−” side input and the reference voltage Vref supplied to the “+” side input into comparison. In the case where the voltage Vt exceeds the reference voltage Vref, the comparator 39 outputs a determination signal. The reference voltage Vref is voltage corresponding with the temperature Tref described in FIG. 4. The voltage Vt (temperature information) is voltage corresponding with the temperature of detecting element T illustrated in FIG. 4.

In the case of normal discharge, Vt≦Vref will be obtained. On the other hand, in the case of the non-discharge, Vt≧Vref will be obtained.

The comparator circuit 39 may be formed on the Si substrate 1 illustrated in FIG. 1 or may be formed on a substrate different from the Si substrate 1.

In addition, the reference voltage Vref supplied to the “+” side input of the comparator circuit 39 may be a fixed value or may be a variable value following environmental temperature and a temperature change at the time of driving. In any case, the value of the reference voltage Vref is set in consideration of the relation among the temperature Tref, the temperature peak value T_{G} in the case of the normal discharge and the temperature a temperature peak value T_{NG} in the case of non-discharge respectively illustrated in FIG. 4.

As described above, according to the present embodiment, arrangement of the temperature detecting element immediately below the electrothermal transducing member to sandwich the insulating layer can configure a temperature detecting circuit with rapid responsiveness and little delay and can realize a circuit enabling precise determination on the states of normal discharge and non-discharge. Within the range without departing the gist hereof, the configuration and operations of the storage apparatus of the present embodiment can be modified appropriately.

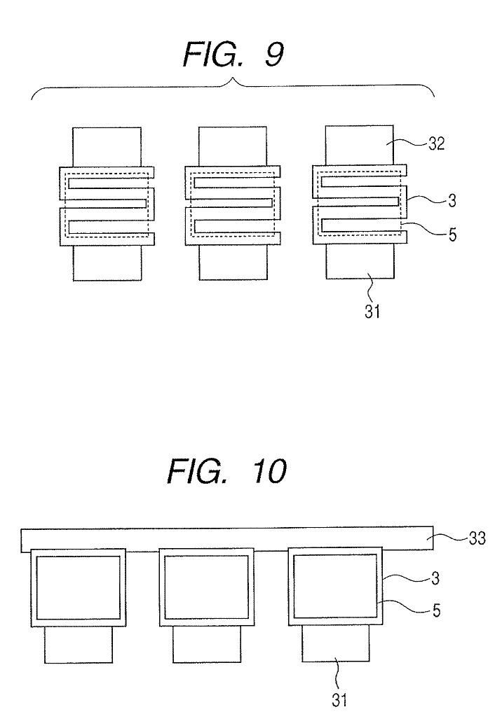

For example, the temperature detecting element 3 may be a linear resistor pattern presenting a shape with a plurality of folds (hereinafter to be referred to as “snake shape”) as illustrated in FIG. 9. The case of using a square-shaped temperature detecting element 3 as illustrated in FIG. 2 can form a flat plane shape for the heaters 5 formed on the temperature detecting element 3 to sandwich the insulating film between layers 4 and can improve stability of discharge operations. In contrast, the case of using the snake shaped temperature detecting element 3 as illustrated in FIG. 9 can set larger resistance vale in the temperature detecting element 3 and therefore enables more accurate detection on micro temperature changes.

### Second Embodiment

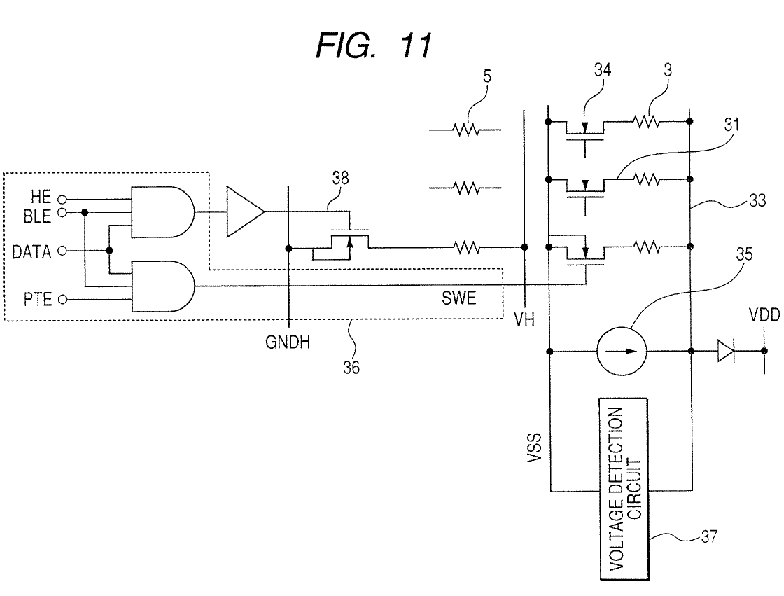

FIG. 10 is a plan view of a recording head mounted on a recording apparatus being a second embodiment of the present invention. In FIG. 10, a discharge nozzle portion including a discharge port, a liquid route and the like is omitted.

The recording head of the present embodiment is obtained by replacing the individual wiring 32 with a common wiring 33 in the recording head illustrated in FIG. 2 and has a stacked structure likewise the one illustrated in FIG. 1. The thin film resistor member included in the temperature detecting element 3 is formed separately and independently immediately below the electrothermal transducing member included in each of heaters 5. Here, the arrangement position of the temperature detecting element 3 is the optimum position obtained as a result of simulation on the above described first embodiment.

An end (terminal) of the temperature detecting element 3 is connected to individual wiring 31. The other end (terminal) is connected to common wiring 33. The individual wiring 31 and the common wiring 33 made of Al and the like and is formed together with the temperature detecting element 3 on the Si substrate.

According to the recording head of the present embodiment, in addition to the characteristic of the first embodiment, the other terminal of the temperature detecting element 3 is structured to include common wiring, giving rise to an advantage in layout so as to enable simpler configuration of the wiring layer. In addition, time-division outputting of outputs (temperature information) from a plurality of temperature detecting elements 3 is enabled to give rise to an advantage in simplifying information processing.

Next, a temperature detecting circuit for outputting time-division outputting of outputs (temperature information) from the temperature detecting elements 3 will be described.

FIG. 11 is a block diagram illustrating a schematic configuration of a control circuit and a temperature detecting circuit applied to the recording head illustrated in FIG. 10. With reference to FIG. 11, individual wiring 31 connected to one terminal of the temperature detecting element 3 is connected to the line provided with voltage VSS via the switching element 34. A constant current circuit 35 for supplying the temperature detecting element 3 with constant current 35 and a voltage detection circuit 37 for detecting voltage are connected to the line provided with the voltage VSS and each of the temperature detecting elements 3 respectively. The individual wiring 31 and the common wiring 33 configure a part of a temperature detecting circuit.

One terminal of the individual heater 5 is connected to the ground line GNDH via the switching element 38. The other terminal of the individual heater 5 is connected to a voltage supplying line VH. The switching elements 34 and 38 include nMOS transistors, for example.

The controlling circuit 36 is provided to each of the discharge nozzles (discharge ports) including the temperature detecting element 3 and the heater 5. The controlling circuit 36 controls the switching element 34 connected to the temperature detecting element 3 and the switching element 38 connected to the heater 5 and includes two AND circuits 36a and 36b. The AND circuit 36a takes a heater applied signal HE, a block selection signal BLE and a stored data DATA as an input respectively to derive logical multiplication of those inputs. The AND circuit 36b takes a block selection signal BLE, a print data DATA and a signal PTE as an input respectively to derive logical multiplication of those inputs. Outputs of the AND circuit 36a are supplied as a switching element controlling signal to the switching element 38 via the amplifying circuit 39. Outputs of the AND circuit 36b are supplied as a switching element controlling signal SWE to the switching element 34.

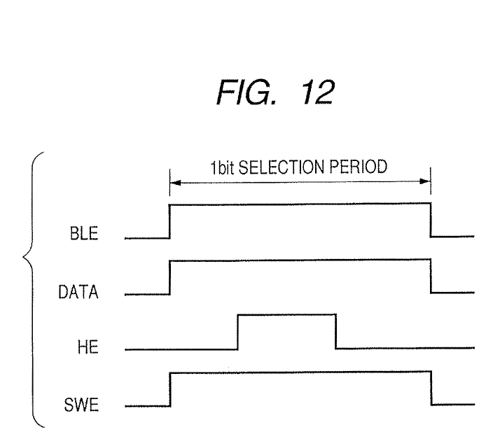

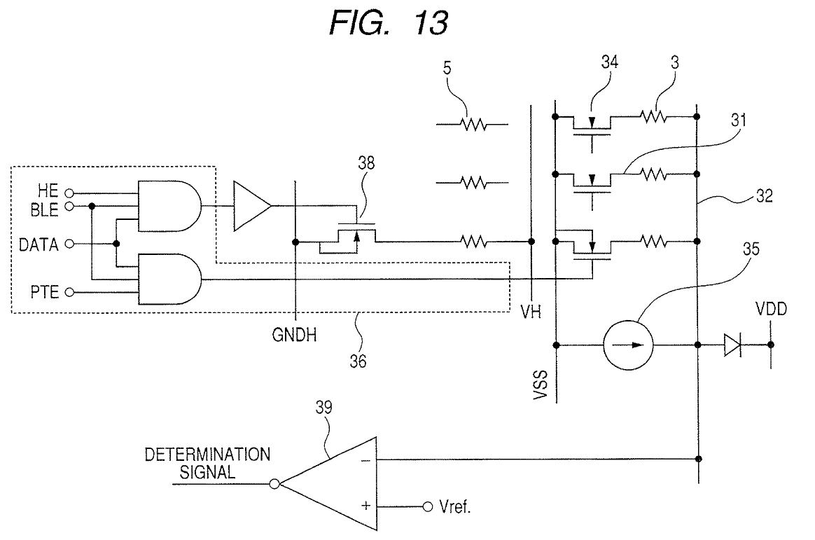

FIG. 12 is a timing chart illustrating operations of the control circuit 36 illustrated in FIG. 11. The block selection signal BLE designates one bit selection period. The stored data DATA is set to take a high level (corresponding with “1”) for the one bit selection period. Therefore, for the period with the block selection signal BLE being on a high level, the outputs of the AND circuit 36a will reach a high level. For the period with the outputs of the AND circuit 36a being on a high level, the switching element 38 is put on to supply the heater 5 with voltage.

The switching element controlling signal SWE being the outputs of the AND circuit 36b will reach a high level for the period with the signal PTE being on a high level. For the period with the outputs of that switching element controlling signal SWE being on a high level, the switching element 34 comes into the on state. The switching element 34 in the on state is connected to the temperature detecting element 3, which is provided with current from the constant current circuit 35. The voltage detection circuit 37 detects voltage corresponding with the resistance value of the temperature detecting element 3.

The heaters 5 transduce electric energy to heat energy. With the heat energy from that heater 5, the temperature detecting element 3 provided immediately below the heaters 5 to sandwich the insulating layer generates temperature changes according to the temperature profiles illustrated in FIG. 4. Thereby, based on the voltage value detected by the voltage detection circuit 37, information (temperature information) corresponding with temperature changes in temperature detecting element 3 thereof is obtainable.

The temperature detecting circuit illustrated in FIG. 11 generates a switching element controlling signal SWE so that each of the switching elements 34 is switched to the on state sequentially. Thereby, the voltage detection circuit 37 will output a signal corresponding with temperature information from each of the switching elements 34 in a time-division state.

The temperature detecting circuit and the controlling circuit may be formed on the Si substrate 1 illustrated in FIG. 1 or may be formed on a substrate different from the Si substrate 1.

Also in the present embodiment, temperature information of the temperature detecting element 3 connected to each of the switching elements 34 is obtained from the output signals of the voltage detection circuit 37 to enable determination on whether a non-discharge state occurs or not based on that obtained temperature information. The determination on the non-discharge state is implemented based on the reference temperature value Tref illustrated in FIG. 4. Specifically, the case where the value of the switching element 34 obtained based on the output signals of the voltage detection circuit 37 exceeds the preset reference temperature value Tref is determined to be a state of non-discharge. The circuit for determining the state of the non-discharge may be formed on the Si substrate 1 illustrated in FIG. 1 or may be formed on a substrate different from the Si substrate 1.

Next, applying the circuit illustrated in FIG. 11, a circuit for outputting the determination signal presenting non-discharge will be described. FIG. 13 illustrates that circuit configuration.

The circuit illustrated in FIG. 13 includes a comparator 39 for each of the controlling circuits 36 in addition to the circuit illustrated in FIG. 11. An “−” side input of that comparator 39 is connected to the common wiring 33 to which the other terminal of the temperature detecting element 3 is connected commonly. The “+” side input of the comparator 39 is provided with reference voltage Vref. The comparator 39 outputs a determination signal.

The comparator 39 brings voltage Vt (temperature information) supplied to the “−” side input and the reference voltage Vref supplied to the “+” side input into comparison and outputs a determination signal based on a comparison result thereof. The reference voltage Vref is voltage corresponding with the temperature Tref described in FIG. 4. The voltage Vt (temperature information) is voltage corresponding with the temperature of detecting element T illustrated in FIG. 4.

In the case of normal discharge, Vt≦Vref will be obtained so that the determination signal is set to the high level (or the signal level on “+” side). In the case of the non-discharge, Vt≧Vref will be obtained so that the determination signal is set to the low level (or the signal level on “−” side).

The comparator circuit 39 may be formed on the Si substrate 1 illustrated in FIG. 1 or may be formed on a substrate different from the Si substrate 1.

In addition, the reference voltage Vref supplied to the “+” side input of the comparator circuit 39 may be a fixed value or may be a variable value following environmental temperature and a temperature change at the time of driving. In any case, the value of the reference voltage Vref is set in consideration of the relation among the temperature Tref, the temperature peak value T_{G} in the case of the normal discharge and the temperature a temperature peak value T_{NG} in the case of non-discharge respectively illustrated in FIG. 4.

Also in the above described present embodiment, arrangement of the temperature detecting element immediately below the electrothermal transducing member can configure a temperature detecting circuit with rapid responsiveness and little delay and can realize a circuit enabling precise determination on the states of normal discharge and non-discharge. Within the range without departing the gist hereof, the configuration and operations of the storage apparatus of the present embodiment can be modified appropriately.

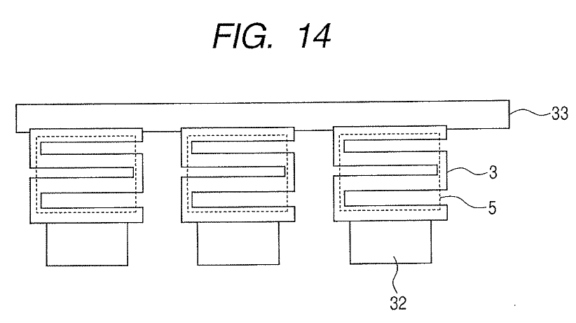

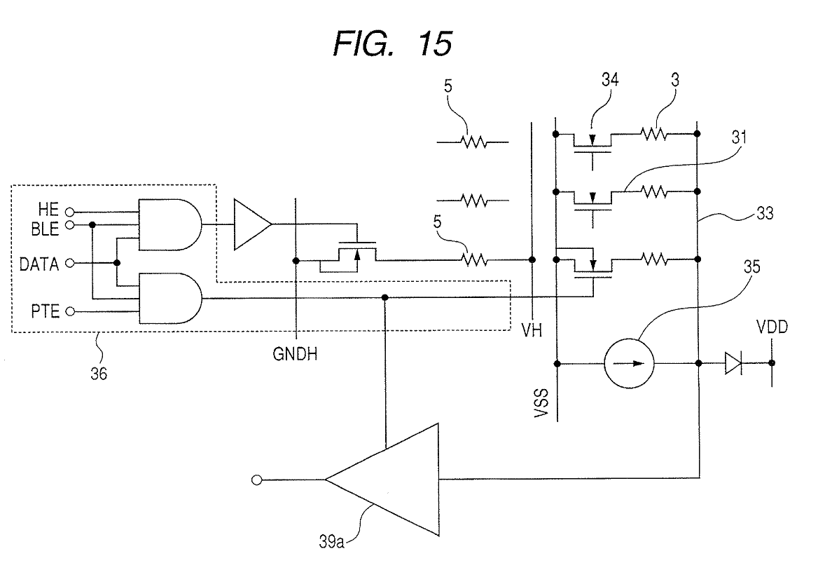

For example, the temperature detecting element 3 may be a linear resistor pattern presenting a shape with a plurality of folds, that is, so-called snake shape as illustrated in FIG. 14. The case of using a square-shaped temperature detecting element 3 as illustrated in FIG. 10 can form a flat plane shape for the heaters 5 formed on the temperature detecting element 3 to sandwich the interlayer insulating film 4 and can improve stability of discharge operations. In contrast, the case of using the snake shaped temperature detecting element 3 as illustrated in FIG. 14 can set larger resistance vale in the temperature detecting element 3 and therefore enables more accurate detection on temperature changes on a micro-level.

In addition, a configuration as illustrated in FIG. 15 may be taken so as to transduce temperature detected through the temperature detecting element 3 to digital values. In such a case, the voltage detection circuit 37 of the circuit illustrated in FIG. 11 is replaced by an AD converter 37a. The input of the AD converter 37a is connected to the common wiring 33. The controlling circuit 36 controls each of the switching elements 34. Thereby information of detected temperature obtained by each of the temperature detecting elements 3 is output from the AD converter 37a on a time-division basis. The configuration with such an AD converter 37a gives rise to an advantage in improvement in noise immunity.

The above described circuit outputting the determination signals and AD converter can be mounted on any of the recording head and the recording apparatus to form an embodiment.

Any of the above described embodiments generates an application stoppage signal in the non-discharge case to enable a stoppage of signal supply to the heaters.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-098674, filed Mar. 31, 2006, and 2007-066591, filed Mar. 15, 2007 which are hereby incorporated by reference herein in their entirety.

What is claimed is:

1. A liquid discharge head comprising a plurality of electrothermal transducing members provided on a substrate to generate heat energy for discharging liquid from a discharge port, including:
a temperature detecting element formed immediately under each of the plurality of electrothermal transducing members to sandwich insulating film; and
a temperature detecting circuit for detecting temperature information from each of the temperature detecting elements.

2. The liquid discharge head according to claim 1, wherein the temperature detecting element is arranged above a heat accumulating layer formed on a head substrate surface.

3. The liquid discharge head according to claim 1, wherein the temperature detecting element is arranged so as to come into a stack with the electrothermal transducing member on a direction perpendicular to the head substrate surface.

4. The liquid discharge head according to claim 1, wherein the temperature detecting circuit comprises:
a constant current circuit having one terminal connected to one of each of the plurality of temperature detecting elements via switching elements and the other terminal commonly connected to the other terminal of each of the plurality of temperature detecting elements; and
a voltage detection circuit for detecting voltage between both terminals of a temperature detecting element brought into an on state and supplied with constant current from the constant current circuit.

5. The liquid discharge head according to claim 1, wherein the temperature detecting circuit outputs temperature information from the plurality of temperature detecting elements in a time-division basis.

6. The liquid discharge head according to claim 4, wherein the temperature detecting circuit further comprises a controlling circuit controlling on and off of the plurality of switching elements.

7. The liquid discharge head according to claim 6, wherein the temperature detecting circuit further comprises switching elements provided to each of the plurality of electrothermal transducing members, for controlling voltage supply to the electrothermal transducing members, and the controlling circuit controls on and off of the another switching element.

8. The liquid discharge head according to claim 5, wherein the temperature detecting circuit further comprises a comparison circuit outputting a determination signal in the case where a voltage value detected by the voltage detection circuit exceeds a reference voltage value.

9. The liquid discharge head according to claim 8, wherein the reference voltage value is larger than a voltage value corresponding with a maximum reach temperature to reach within a predetermined period in a normal discharge state discharging the liquid from the discharge port and not more than a voltage value corresponding with a maximum reach temperature to reach within a predetermined period in a non-discharge state not discharging the liquid from the discharge port.

10. The liquid discharge head according to claim 1, wherein the temperature detecting elements are rectangular thin film resistor members respectively.

11. The liquid discharge head according to claim 1, wherein the temperature detecting elements respectively are thin film resistor members provided with a plurality of folds to present a linear pattern.

12. A liquid discharge apparatus comprising:
a liquid discharge head provided with a plurality of electrothermal transducing members on a substrate to generate heat energy for discharging liquid from a discharge port so that the liquid discharge head has a temperature detecting element immediately under each of the plurality of electrothermal transducing members to sandwich insulating film between layers and a temperature detecting circuit for detecting temperature information from each of the temperature detecting element; and
a controlling portion for controlling a drive of the liquid discharge head so that the controlling portion outputs a determination signal in the case where temperature information detected by the temperature detecting circuit exceeds a reference value.

13. The liquid discharge apparatus according to claim 12, wherein the determination signal stops voltage supply to an electrothermal transducing member.

14. The liquid discharge apparatus according to claim 12, wherein the reference voltage value is larger than a voltage value corresponding with a maximum reach temperature to reach within a predetermined period in a normal discharge state discharging the liquid from the discharge port and not more than a voltage value corresponding with a maximum reach temperature to reach within a predetermined period in a non-discharge state not discharging the liquid from the discharge port.
